(19) United States
(12) Patent Application Publication
(10) Pub. No.: US 2017/0323159 A1
(43) Pub. Date: Nov. 9, 2017

(54) Methods Circuits Devices Assemblies Systems and Associated Machine Executable Code For Obstacle Detection

(71) Applicant: SMART THIRD-I LTD., Sderot, IL (US)

(72) Inventor: Amos Cohen, Even Yehuda (IL)

(21) Appl. No.: 15/220,418

(22) Filed: Jul. 27, 2016

Related U.S. Application Data
(60) Provisional application No. 62/333,197, filed on May 7, 2016.

(51) Int. Cl. G06K 9/00; H04M 1/02

(52) U.S. Cl. CPC G06K 9/00671; H04M 1/0264; H04M 1/0266

(57) ABSTRACT

Disclosed are methods, circuits, devices, systems and functionally associated machine executable code for obstacle avoidance and/or providing location related indicators/information. According to embodiments, there may be provided a mobile communication device comprising a digital display assembly with a digital display panel and display driving circuits to selectively drive current to display elements of the display panel in accordance with instructions provided by a processing unit. The processing unit is configured to instruct said display circuits to cause said display panel to display a screen including both user selected information and a video feed from a walking camera functionally associated with the mobile communication device.

### FIELD OF THE INVENTION

The present invention relates generally to the field of electronical devices and mobile communication devices. More specifically, the present invention relates to methods, circuits, devices, assemblies, systems and associated machine executable code for obstacle detection.

### BACKGROUND

Mobile communication devices are a prevalent part of modern daily life. Although originally conceived as a communication device to provide speech communication between people, the mobile communication device since becoming a data appliance, has become central to people's interactions, communications, and activities with each other and with online data services. Many people have become so dependent on their mobile communication devices, they use their mobile communication devices while doing other activities, such as walking on the street.

The hazards of interacting with a mobile communication device while performing the other activities have sadly become well documented. Numerous accidents, injuries and in some extreme cases death have been documented for people walking and looking at a mobile communication device screen. People walking down a street while typing a text onto the mobile communication device have been seen walking into lampposts, puddles and even into oncoming vehicular traffic.

Since a mobile device user's concentration is directed onto the screen of the mobile device when using the device, it is not recommended to use the device and walk at the same time. Due to the angle at which a user is usually looking at the mobile device screen, and due to various sizes of the mobile device, the user cannot rely on peripheral vision to be attentive of where they're heading. Hitting or being hit by obstacles, falling due to changes of the ground surface (e.g. cubs, potholes, etc.) and various other risks are ever-present when walking while looking at a screen of a mobile device.

### SUMMARY OF THE INVENTION

The present invention includes methods, circuits, devices, assemblies, systems and associated machine executable code for obstacle detection. According to some embodiments, there may be provided a mobile device obstacle sensor assembly (MDOSA) to sense obstacles in the path of a mobile device while the user is looking at the mobile device screen. According to embodiments, the MDOSA may include one or more image sensors either integral or otherwise functionally associated with a mobile communication device. The MDOSA may be part of a mobile device obstacle detection system (MDODS) adapted to alert a mobile device user, for example who might be looking at a screen or display of the mobile device, of obstacles or other relevant conditions or objects in the user's path. According to some embodiments, the MDOSA may also be referred to as a walking camera.

According to some embodiments of the present invention, the MDODS may be integral or otherwise functionally associated with a mobile device accessory or add-on, such as for example a mobile device case or protective cover. The MDOSA according to such embodiments may include one or more image sensors, for example one or more CMOS camera modules embedded within, or otherwise connected to, the device case/cover, in such a position and with such orientation that the image sensors face in a forward direction, relatively in front of a user who is walking and looking at a screen of the device with which the case of cover is associated. The MDOSA may include an illuminator, for example a flash or a structured light source. Image information acquired by the one or more forward facing image sensors, 2D or 3D, may be sent to and displayed by a screen or display of the mobile device with which the MDODS case or cover is associated. The acquired image information may also be analyzed by one or more image processing circuits to detect obstacles in a path of a user.

An MDODS according to a case or cover embodiment of the present invention may include circuits within the add-on case or cover. The MDODS circuits may include interface circuits for interfacing with and transferring data to an associated mobile device. The transferred data may include image or video data acquired by image sensors of the case or cover. The MDODS' interface circuits for communicating with the associated mobile device may comply with a wired standard such USB, Micro-USB, HDMI, Micro-HDMI, Firewire, Apple, etc. The MDODS' interface circuits for communicating with the associated mobile device may comply with a wireless standard such a Bluetooth, WiFi, NFC, ZigBee, etc.

According to some embodiments, image processing of acquired images, for example to detect obstacles and other conditions of which a user should be alerted, may be performed by processing circuits of the associated mobile device in accordance with machine executable code of the MDODS. The machine executable code may include instructions to cause processing circuits of the mobile device to: (1) detect features within an acquired image, (2) estimate relative position of detected features, (3) estimate relative distance of detected features, (4) estimate trajectories of objects associated with detected features, (5) estimate a trajectory of the mobile device user, (6) detect potential collisions between the mobile device user and objects associated with detected features, and (7) issue warming signaling responsive to any one or more of the detections. According to further embodiments, the accessory based MDODS may include image processing circuits to perform one or more above listed image processing functions.

A user of a mobile device according to embodiments may be alerted of an obstacle or condition detected by the MDODS via a visual alert rendered on the screen of the device, at which screen the user is looking, and/or via an audible alert generated by the audio rendering assembly of the mobile device. Optionally, the MDODS may cause the mobile device to vibrate and provide tactile output upon detection of an obstacle or other condition.

According to further embodiments, the MDODS may include or be otherwise functionally associated with one or more location based services, such as for example navigation. According to some embodiments of the present invention, a navigation system, such as a GPS based navigation system, integral or otherwise functionally associated with the MDODS, may generate navigation instructions as a function of a user designated destination and a current location as detected, for example, by a GPS. According to embodiments, navigation instructions can be rendered as graphical indicators on the MDODS portion of the associated mobile device. According to further embodiments, the graphical navigation instruction indicators may be overlaid upon a display of a video feed from a forward looking camera or walking camera associated with the mobile communication device.

According to further embodiments, other location based services integral or otherwise functionally associated with the MDODS may include: (a) location specific advertising, (b) notification of nearby points of interest, and/or (c) any other location based services known today or to be devised in the future. Output from such locations based services may be displayed by the MDODS, optionally as an overlay on-top of a display of the video feed from the forward looking camera.

According to some embodiments, the MDODS and an associated MDOSA may be integral with and/or embedded within a mobile communication device such as a smartphone, PDA, Tablet computer, or the like.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B illustrate a dangerous situation in which a mobile device user walks while staring at a mobile device screen, heads towards an obstacle, and strikes the obstacle as a consequence of walking while staring at the mobile device screen;

FIGS. 2A and 2B illustrates another situation in which a mobile device user heads towards an obstacle while walking and staring at the screen of a mobile device including a MDODS according to embodiments, and thus the user avoids hitting the obstacle due to the use of the MDODS;

FIG. 3A is a prospective view of a mobile communication device with an exemplary MDODS according to embodiments where the MDOSA is integrated into the mobile device;

FIG. 3B is a prospective view of a mobile communication device with an exemplary MDODS according to embodiments where the MDOSA is integrated into a case add-on covering the mobile communication device;

FIG. 3C is a prospective view of a mobile communication device with an exemplary MDODS according to embodiments including two stereoscopically arranged MDOSA's, integrated in a case add-on covering the mobile communication device;

FIG. 4 is a functional block diagram of a device integral or otherwise functionally associated with an MDODS according to embodiments of the present invention;

FIG. 5 is a flow diagram including steps of a method of obstacle detection and notification in accordance with embodiments of the present invention; and

FIGS. 6A to 6E illustrate wireframes of exemplary screen or display arrangement of a mobile device configured in accordance with embodiments of the present invention and displaying a combination of mobile device and MDODS related information on the same screen.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention may include a mobile communication device assembly comprising a digital display assembly having a digital display panel and display driving circuits to selectively drive current to display elements of the display panel in accordance with instructions provided by a processing unit. The processing unit may be configured to instruct said display circuits to cause said display panel to display a screen including user selected information and a walking camera image. The walking camera may be integral with a chassis of said mobile communication device. A field of view of the walking camera relative to the communication device may be adjustable either physically or digitally.

According to some embodiment, the assembly may include a mobile communication device case with which the walking camera is integral. The walking camera may include two or more image sensors. The walking camera may include a structured light imaging sensor assembly adapted to sense depth of objects in the field of view of the walking camera.

According to embodiments, the processing circuits may perform image processing on one or more images produced by said walking camera. The processing circuits may perform one or more image processing routines to identify within one or more walking camera images obstacles in a path of the mobile communication device assembly. The processing circuits may generate one or more alert signals responsive to a detection of an obstacle in a path of the mobile communication device assembly. The processing circuits may process location related information and cause said display panel to display location related indicators.

The present invention may include a computer implemented method of obstacle avoidance during operation of mobile communication device, said method comprising, wherein the method may include receiving a video feed from a walking camera functionally associated with the mobile communication device. The method may also include displaying on a display of the mobile communication device a composite screen including both user selected information and the video feed from the walking camera. The method may include changing a field of view of said walking camera relative to the communication either physically or digitally.

The method may include execution of image processing routines on the walking camera video feed so as to identify within one or more walking camera images obstacles in a path of the mobile communication device assembly. The method may further include generating an alert signal responsive to a detection of an obstacle in a path of the mobile communication device. The method may also include receiving and processing location related information and displaying location related indicators on the display of the mobile communication device.

The present invention includes methods, circuits, devices, assemblies, systems and associated machine executable code for obstacle detection. According to some embodiments, there may be provided a mobile device obstacle sensor assembly (MDOSA) to sense obstacles in the path of a mobile device while the user is looking at the mobile device screen. According to embodiments, the MDOSA may include one or more image sensors either integral or otherwise functionally associated with a mobile communication device. The MDOSA may be part of a mobile device obstacle detection system (MDODS) adapted to alert a mobile device user, for example who might be looking at a screen or display of the mobile device, of obstacles or other relevant conditions or objects in the user's path. According to some embodiments, the MDOSA may also be referred to as a walking camera.

According to some embodiments of the present invention, the MDODS may be integral or otherwise functionally associated with a mobile device accessory or add-on, such as for example a mobile device case or protective cover. The MDOSA according to such embodiments may include one or more image sensors, for example one or more CMOS camera modules embedded within, or otherwise connected to, the device case/cover, in such a position and with such orientation that the image sensors face in a forward direction, relatively in front of a user who is walking and looking at a screen of the device with which the case of cover is associated. The MDOSA may include an illuminator, for example a flash or a structured light source. Image information acquired by the one or more forward facing image sensors, 2D or 3D, may be sent to and displayed by a screen or display of the mobile device with which the MDODS case or cover is associated. The acquired image information may also be analyzed by one or more image processing circuits to detect obstacles in a path of a user.

An MDODS according to a case or cover embodiment of the present invention may include circuits within the add-on case or cover. The MDODS circuits may include interface circuits for interfacing with and transferring data to an associated mobile device. The transferred data may include image or video data acquired by image sensors of the case or cover. The MDODS' interface circuits for communicating with the associated mobile device may comply with a wired standard such USB, Micro-USB, HDMI, Micro-HDMI, Firewire, Apple, etc. The MDODS' interface circuits for communicating with the associated mobile device may comply with a wireless standard such a Bluetooth, WiFi, NFC, ZigBee, etc.

According to some embodiments, image processing of acquired images, for example to detect obstacles and other conditions of which a user should be alerted, may be performed by processing circuits of the associated mobile device in accordance with machine executable code of the MDODS. The machine executable code may include instructions to cause processing circuits of the mobile device to: (1) detect features within an acquired image, (2) estimate relative position of detected features, (3) estimate relative distance of detected features, (4) estimate trajectories of objects associated with detected features, (5) estimate a trajectory of the mobile device user, (6) detect potential collisions between the mobile device user and objects associated with detected features, and (7) issue warming signaling responsive to any one or more of the detections. According to further embodiments, the accessory based MDODS may include image processing circuits to perform one or more above listed image processing functions.

A user of a mobile device according to embodiments may be alerted of an obstacle or condition detected by the MDODS via a visual alert rendered on the screen of the device, at which screen the user is looking, and/or via an audible alert generated by the audio rendering assembly of the mobile device. Optionally, the MDODS may cause the mobile device to vibrate and provide tactile output upon detection of an obstacle or other condition.

According to further embodiments, the MDODS may include or be otherwise functionally associated with one or more location based services, such as for example navigation. According to some embodiments of the present invention, a navigation system, such as a GPS based navigation system, integral or otherwise functionally associated with the MDODS, may generate navigation instructions as a function of a user designated destination and a current location as detected, for example, by a GPS. According to embodiments, navigation instructions can be rendered as graphical indicators on the MDODS portion of the associated mobile device. According to further embodiments, the graphical navigation instruction indicators may be overlaid upon a display of a video feed from a forward looking camera or walking camera associated with the mobile communication device.

According to further embodiments, other location based services integral or otherwise functionally associated with the MDODS may include: (a) location specific advertising, (b) notification of nearby points of interest, and/or (c) any other location based services known today or to be devised in the future. Output from such locations based services may be displayed by the MDODS, optionally as an overlay on-top of a display of the video feed from the forward looking camera.

According to some embodiments, the MDODS and an associated MDOSA may be integral with and/or embedded within a mobile communication device such as a smartphone, PDA, Tablet computer, or the like.

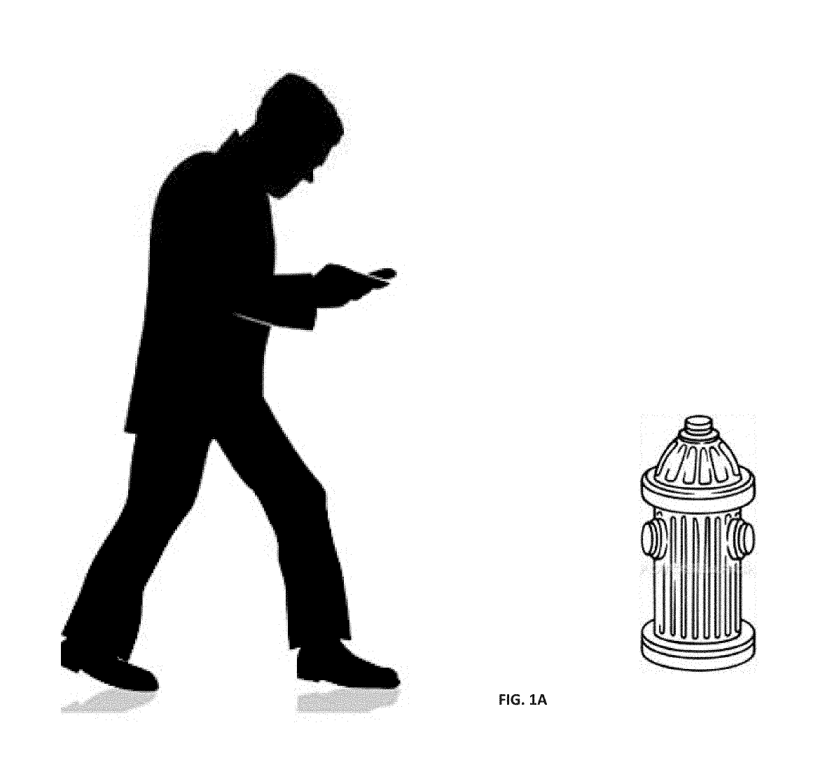

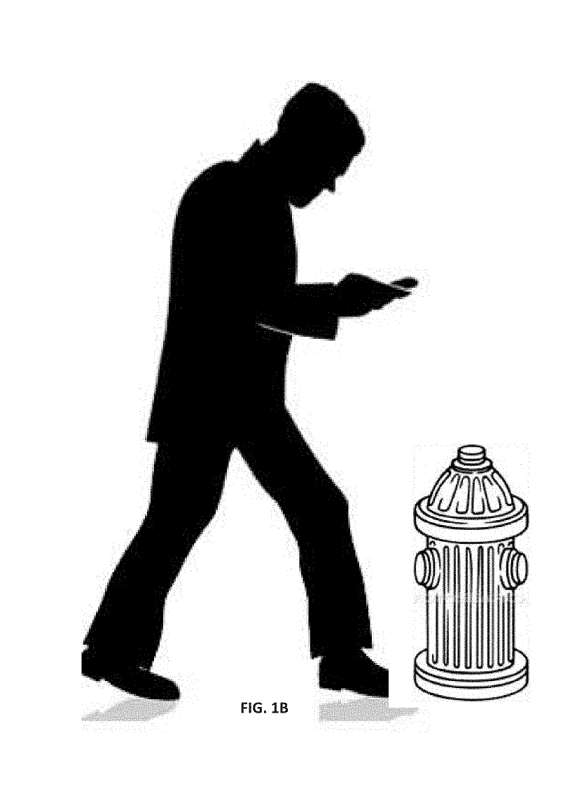

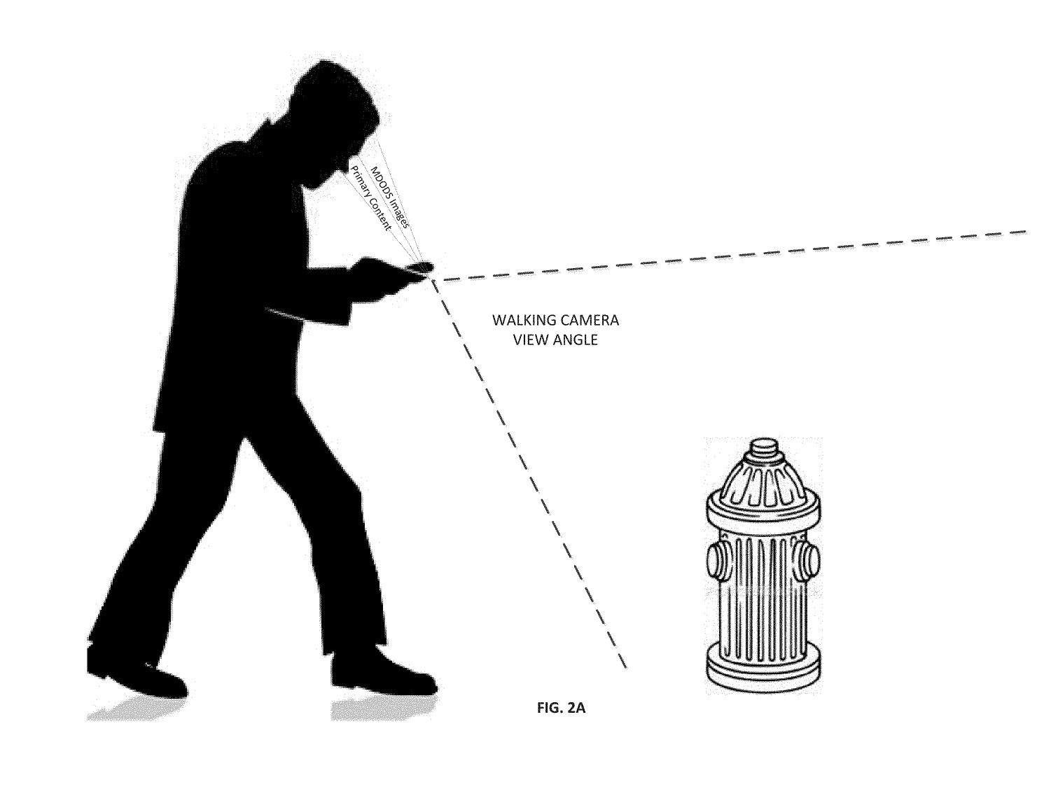

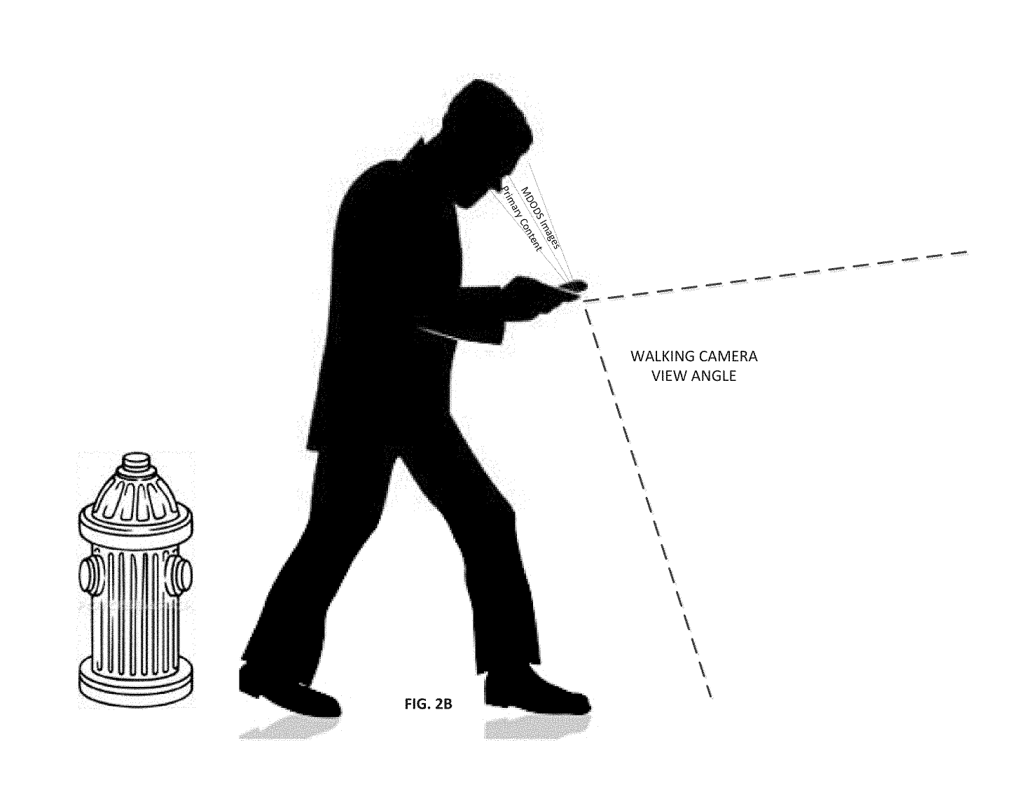

Turning now to FIGS. 1A and 1 B, there is illustrated a dangerous situation in which a mobile device user walks while staring at a mobile device screen, heads towards an obstacle, and strikes the obstacle as a consequence of walking while staring at the mobile device screen. Alternatively, FIGS. 2A and 2B illustrate another scenario in which a mobile device user heads towards an obstacle while walking and staring at the screen of a mobile device including a MDODS, according to embodiments of the present invention. According to this second scenario, the user avoids hitting the obstacle due to the use of the MDODS which: (a) shows the user the approaching obstacle on the device screen, and optionally (b) generates an obstacle alert/notification responsive to a computer vision based obstacle detection process running on image processing circuits integral or otherwise functionally associated with the MDODS.

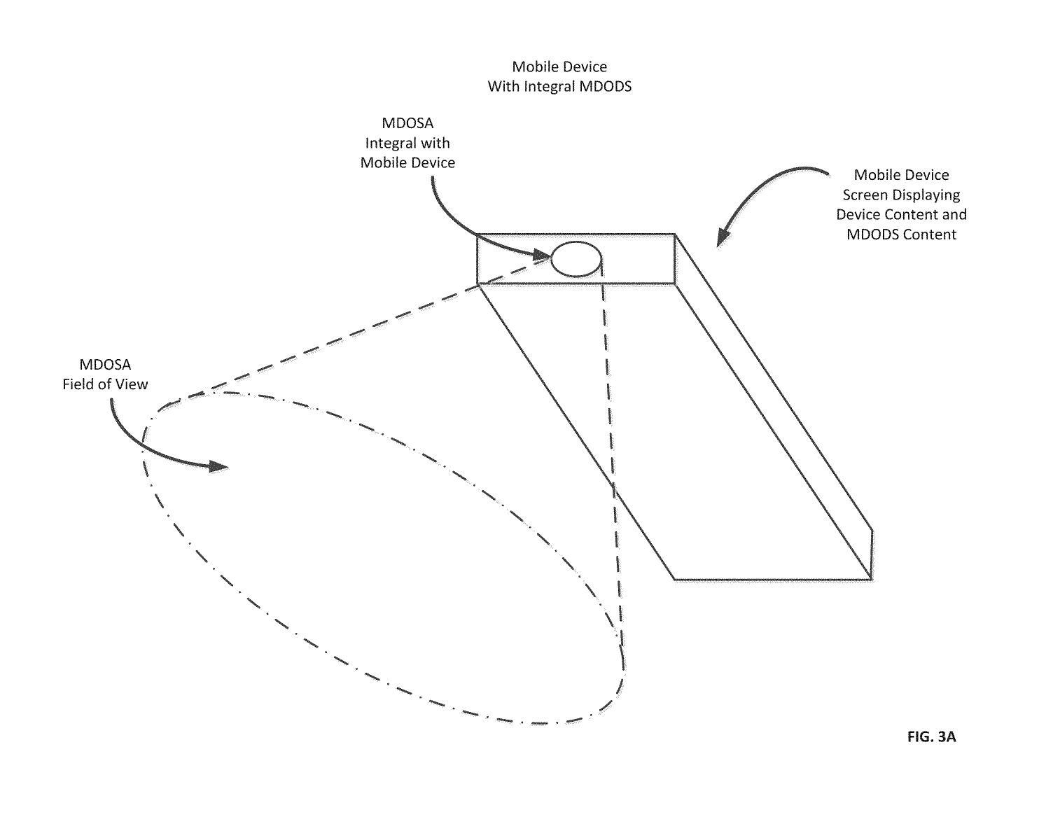

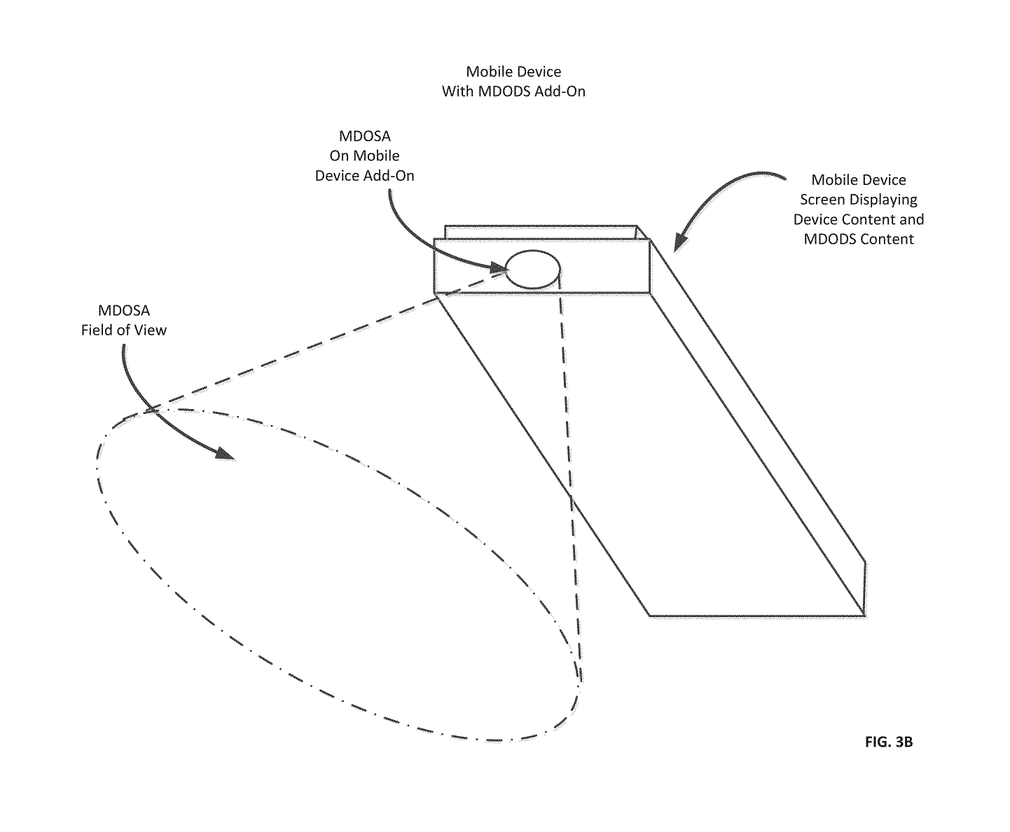

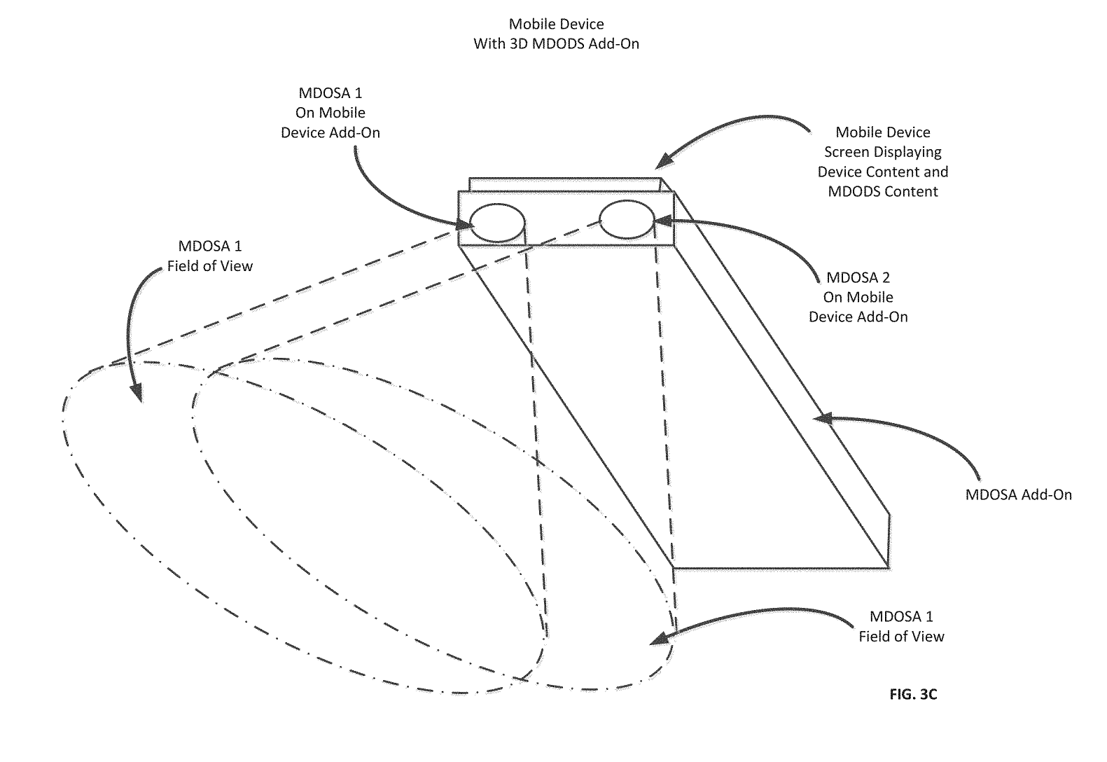

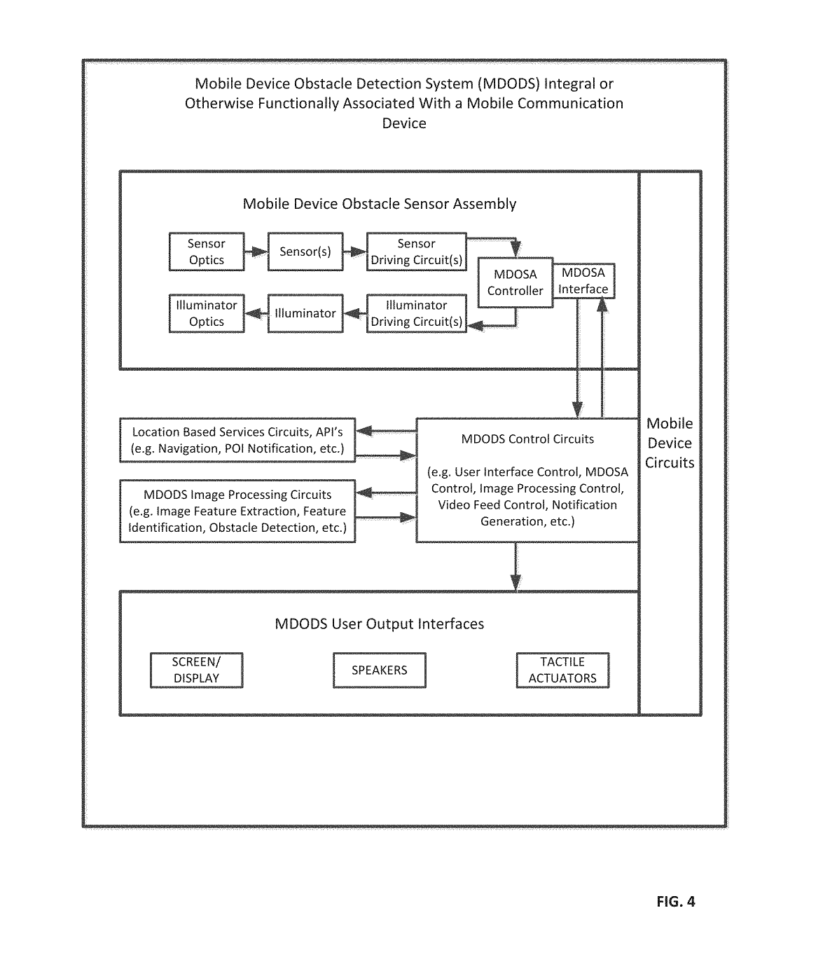

Turning now to FIG. 3A, there is shown a prospective view of an exemplary mobile communication device with an exemplary MDODS according to embodiments where an MDOSA of an MDODS is integrated into the mobile communication device. The MDOSA shown in FIG. 3A may be referred to as walking camera and is oriented such that it's field of view faces forward and a bit downward relative to a standing or walking user holding the mobile communication device at an angle such as, for example, 20 deg to 80 deg relative to a vertical axis of the user's standing body, as is common when a mobile device user looks at the device screen during standing or walking. Other components, circuits and functional blocks of the MDODS, not shown 3A, may also be integral with the mobile device, either as dedicated circuits or as computer executable code/instructions running on programmable processing circuits of the mobile device. FIG. 4 shows circuits and functional block of a MDODS according to embodiments.

Turning now to FIG. 3B, there is shown a prospective view of a mobile communication device with an exemplary MDODS according to embodiments where the MDOSA is integrated into a case or cover add-on covering the mobile communication device. Other components, circuits and functional blocks of the MDODS, not shown 3B, may also be integral with either the case of the mobile device, either as dedicated circuits or as computer executable code/instructions running on programmable processing circuits of the mobile device. FIG. 4 shows circuits and functional block of a MDODS according to embodiments, which circuits and functional blocks may be distributed across the case and/or the mobile communication device.

FIG. 3C shows a case or cover add-on embodiment including two MDOSA's. Each MDOSA may include an imaging sensor, imaging optics and optionally an illuminator. Embodiments including a structured light illuminator may include a corresponding 3D decoder which may provide depth information for points on objects imaged by the MDOSA. Likewise, embodiments including multiple MDOSA's configured in a stereoscopic arrangement and including a disparity map based depth estimator may also provide depth information for points on the objects imaged by the MDOSA(s). Other components, circuits and functional blocks of the MDODS, not shown 3C, may also be integral with either the case of the mobile device, either as dedicated circuits or as computer executable code/instructions running on programmable processing circuits of the mobile device. FIG. 4 shows circuits and functional block of a MDODS according to embodiments, which circuits and functional blocks may be distributed across the case and/or the mobile communication device.

According to any of the configurations of FIGS. 3A through 3C, a relative direction of a line of site of one or more image sensors relative to the communication device may be adjustable. The line of site may be adjusted by physically changing a relative direction of a aperture the one or more sensors relative to the communication device. The physical direction may be changed manually or using electromechanical actuators. Alternatively, the line of site may be adjusted digitally by changing filtration of the output from one or more wide angle sensors.

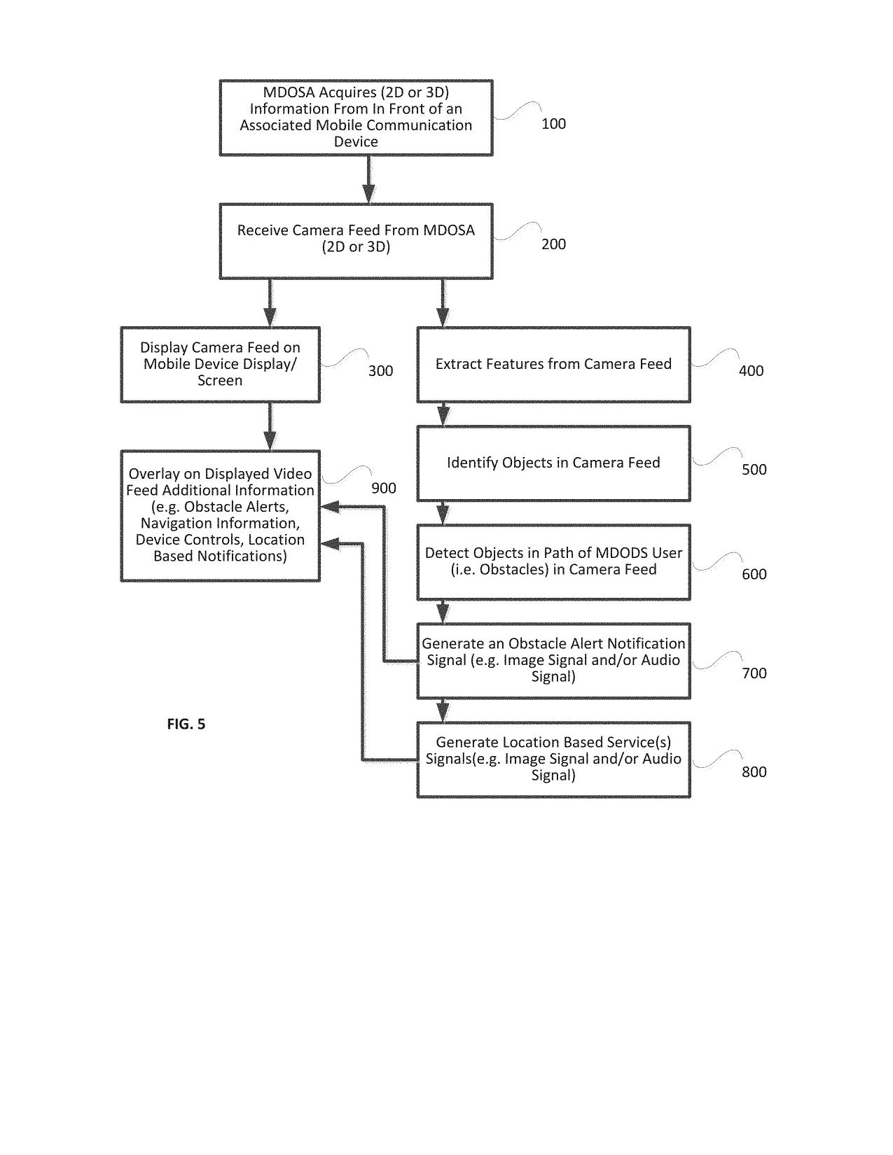

Turning now to FIG. 4, there is shown a block diagram of a mobile device integral or otherwise functionally associated with an MDODS according to embodiments of the present invention. The combined operation of a mobile communication device and MDODS, irrespective of whether the two are integral or are otherwise functionally associated, may be described with reference to the steps shown in FIG. 5, wherein FIG. 5 is a flow diagram including steps of a method of obstacle detection and location based notification in accordance with embodiments of the present invention.

The Mobile Device Obstacle Sensor Assembly (MDOSA) of FIG. 4 includes both an optical sensor(s) and an illuminator, which illuminator may be a structured light illuminator. The MDOSA includes a controller to regulate operation of the sensor(s) and the illuminator and to produce an electrical signal or video stream indicative of images acquired by the sensor(s) or camera feed (FIG. 5, Step 100). The camera feed is received by the MDODS (FIG. 5, Step 200) and optionally rendered on a screen of the device (FIG. 5, Step 300). Image Processing Circuits of MDODS extract features from the camera feed (FIG. 5, Step 400), identify objects in the camera feed (FIG. 5, Step 500), detect objects in the path of the MDODS user (FIG. 5, Step 600), and generate obstacle related notifications/signals (FIG. 5, Step 700). According to further embodiments, a location based service, such as a navigator, may also generate location specific notifications/signals (FIG. 5, Step 800). Video based notifications from the image processor's obstacle detector and/or from the location based service(s) circuits may be rendered on the mobile device's display/screen, wherein display may include an overlay on top of displayed camera feed (FIG. 5, Step 900). Other types of MDODS notifications may be provided to a user through speakers and/or through tactile actuators.

According to further embodiment the processing circuitry of the MDODS, either dedicated or code running on the mobile device processor, may render an image on the display indicative of sensed objects. Rendering may be a function of mobile device orientation and velocity vector. Acquired wide-angle images may be cropped to only show objects in a user's path. The processing circuits may detect obstacles within an image acquired by the MDOSA using any computer vision technique known today or to be developed in the future. The processing circuits extrapolate distance of detected obstacles using stereoscope depth mapping or by image comparison with reference objects having known sizes.

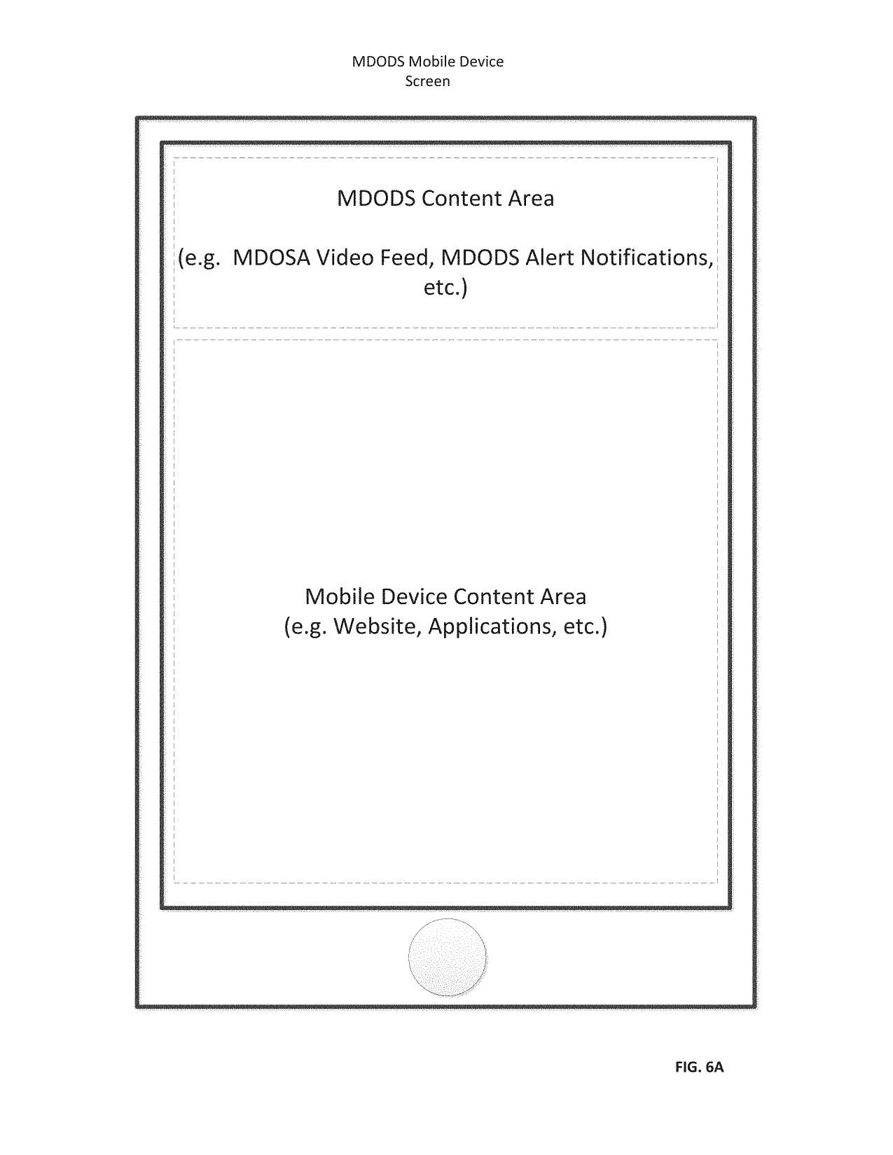

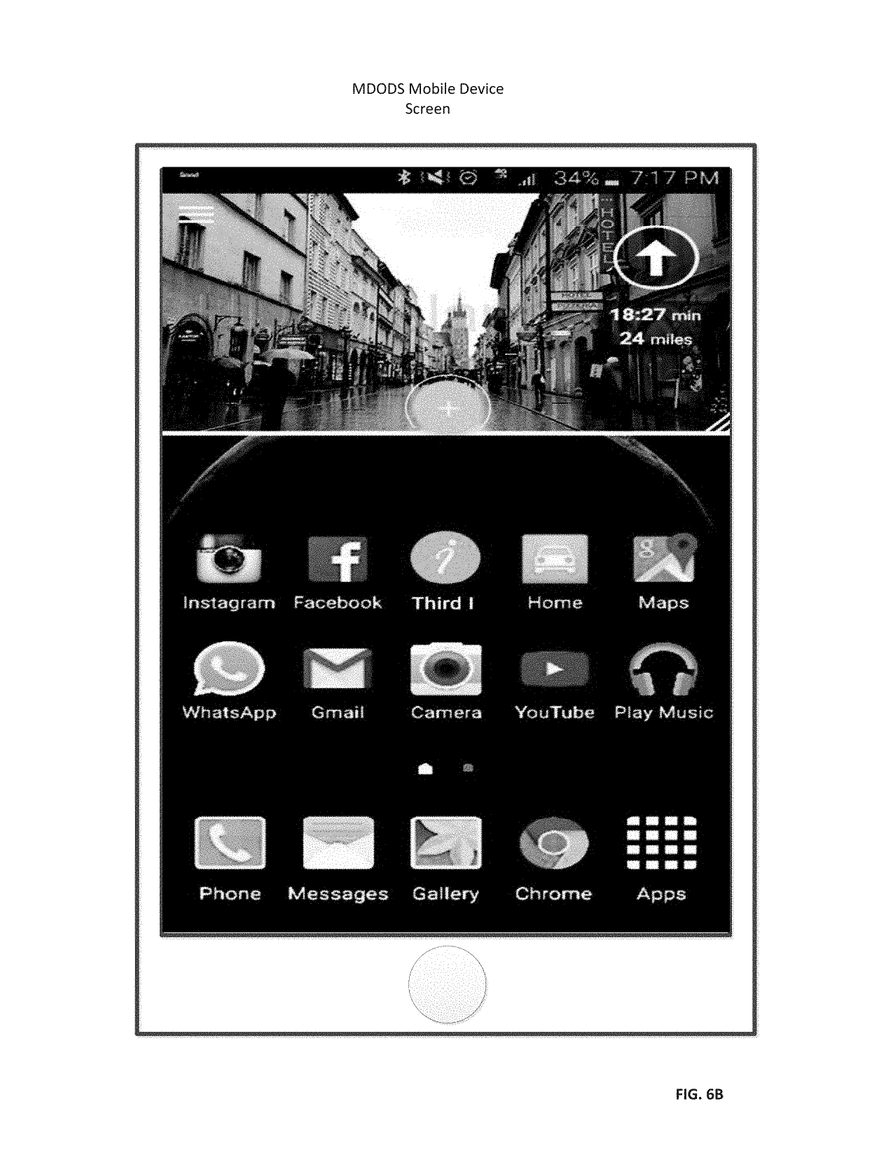

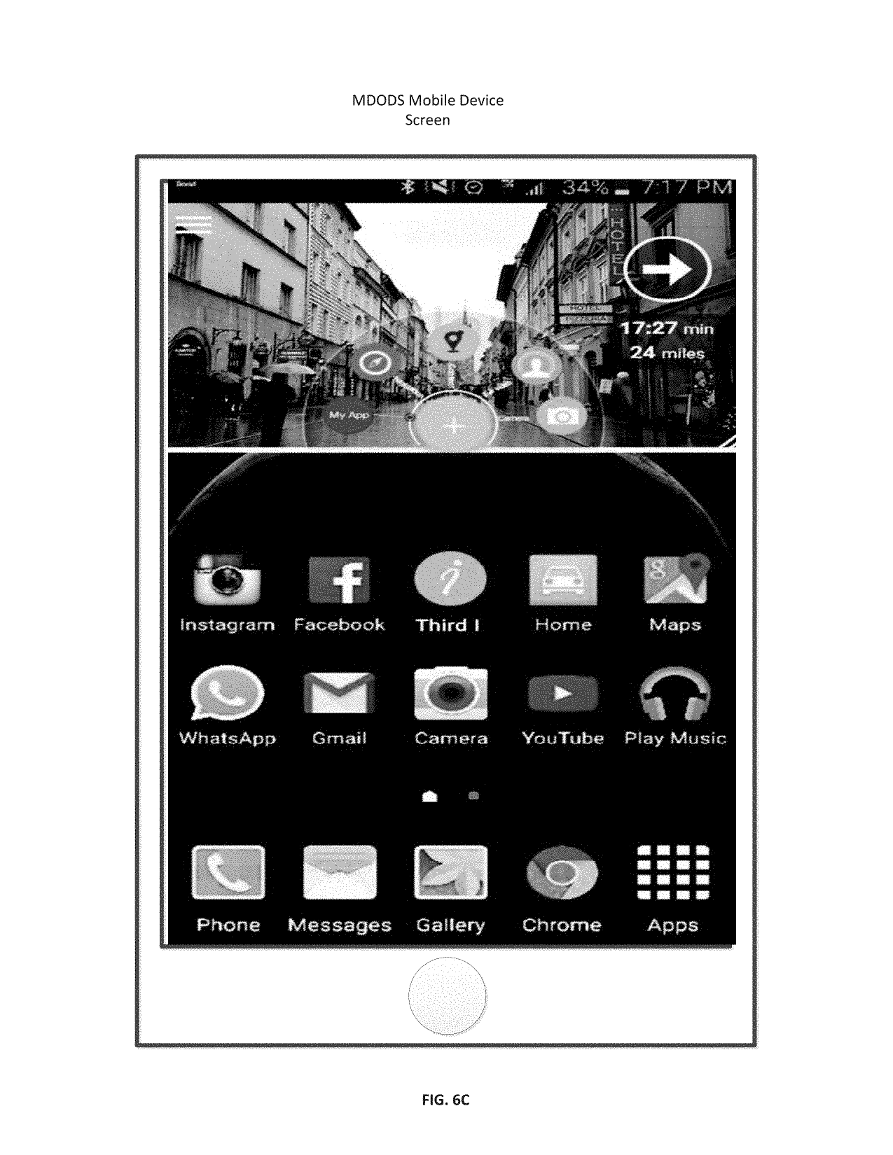

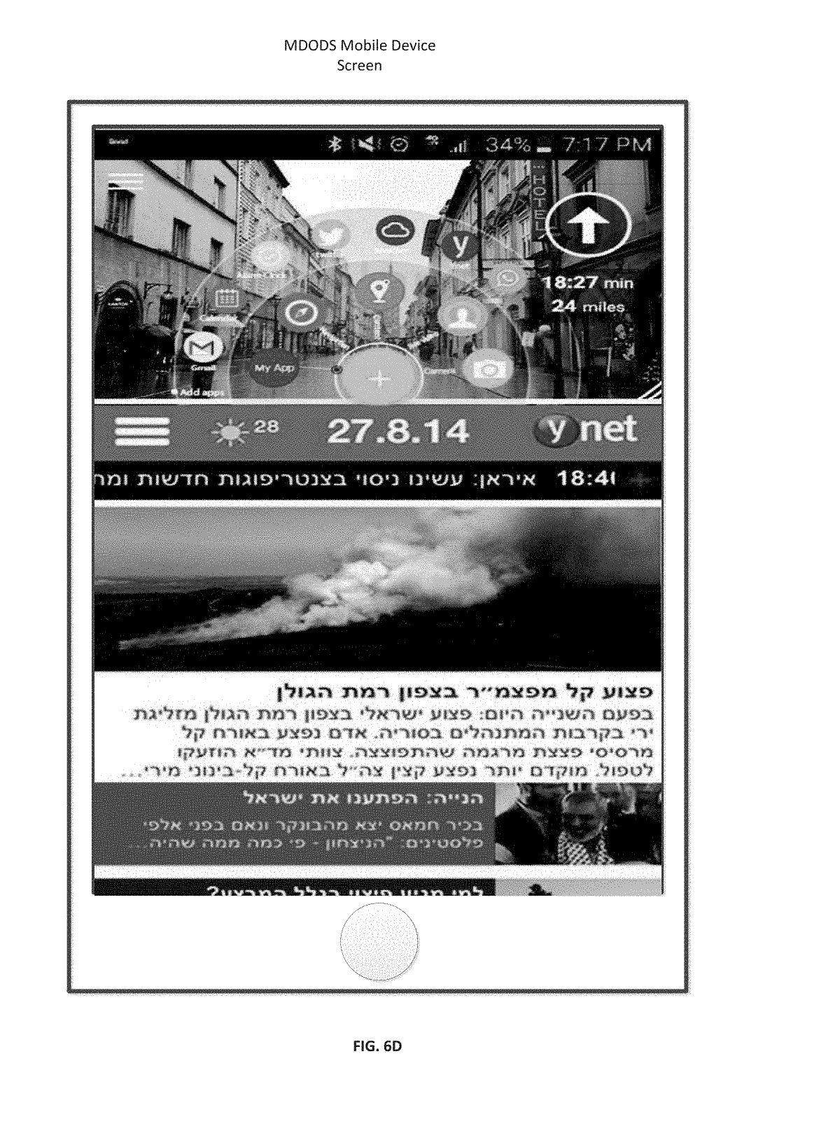

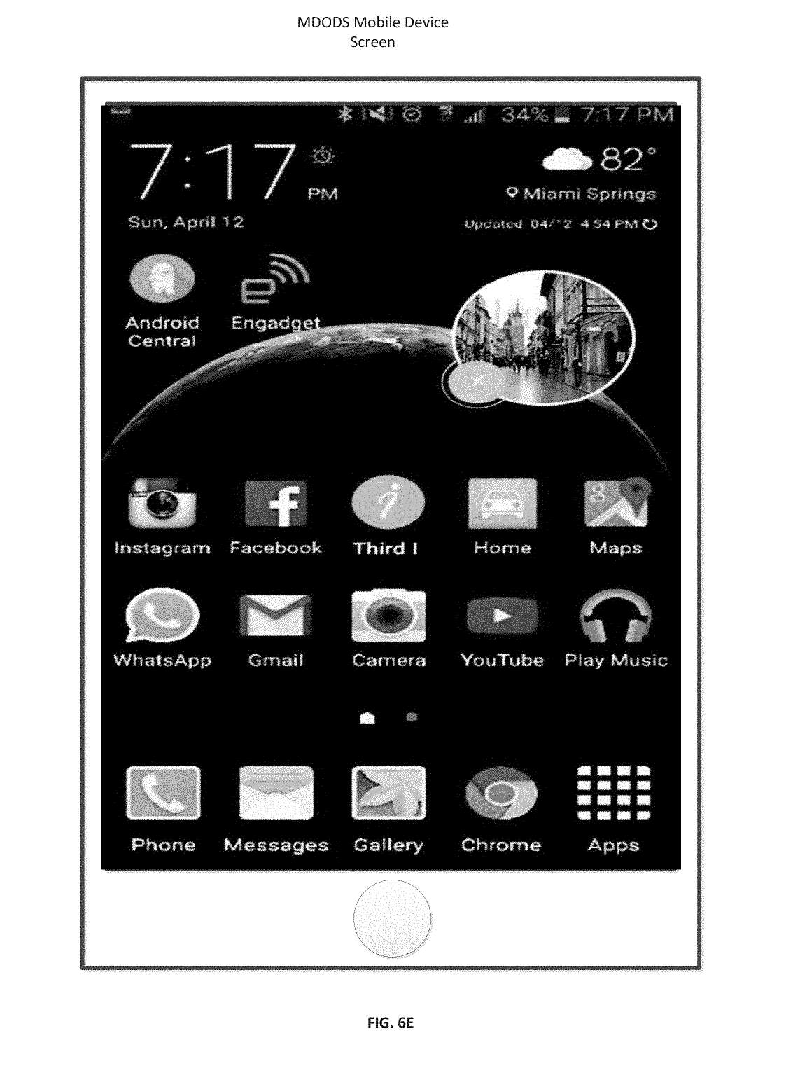

Turning now to FIGS. 6A through 6E, there are shown various exemplary screens or display arrangement of mobile devices with MDODS and configured in accordance with embodiments of the present invention. FIG. 6A illustrates an exemplary mobile device with a screen or display which is segmented or partitioning into two display areas, one area for user selected content and one area for MDODS related graphics. FIG. 6B illustrates exemplary content which can be shown on the user selected content area and a walking camera feed which can be displayed on the MDODS related display or screen area. FIG. 6C illustrates an embodiment where some of the content displayed in the MDODS, in addition to a video feed from a walking camera, is navigation information or indicators. FIGS. 6D and 6E illustrate communication device display configurations according to embodiments where the MDODS display/screen areas included various location related information and/or have various shapes and sizes.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A mobile communication device assembly comprising:
a digital display assembly including a digital display panel and display driving circuits to selectively drive current to display elements of the display panel in accordance with instructions provided by a processing unit; and
processing circuits configured to instruct said display circuits to cause said display panel to display a screen including user selected information and a walking camera image.

2. The assembly according to claim 1, wherein said walking camera is integral with a chassis of said mobile communication device.

3. The assembly according to claim 2, wherein a field of view of said walking camera relative to the communication device is adjustable either physically or digitally.

4. The assembly according to claim 1, further including a mobile communication device case with which said walking camera is integral.

5. The assembly according to claim 4, wherein a field of view of said walking camera relative to the communication device is adjustable either physically or digitally.

6. The assembly according to claim 1, wherein said processing circuits perform image processing on one or more images produced by said walking camera.

7. The assembly according to claim 6, wherein said processing circuits perform one or more image processing routines to identify within one or more walking camera images obstacles in a path of the mobile communication device assembly.

8. The assembly according to claim 7, wherein said processing circuits generate one or more alert signals responsive to a detection of an obstacle in a path of the mobile communication device assembly.

9. The assembly according to claim 1, wherein said processing circuits process location related information and cause said display panel to display location related indicators.

10. A computer implemented method of obstacle avoidance during operation of mobile communication device, said method comprising:
receiving a video feed from a walking camera functionally associated with the mobile communication device; and
displaying on a display of the mobile communication device a composite screen including both user selected information and the video feed from the walking camera.

11. The method according to claim 10, wherein said walking camera is integral with a chassis of said mobile communication device.

12. The method according to claim 10, wherein a field of view of said walking camera relative to the communication device is adjusted either physically or digitally.

13. The method according to claim 10, wherein the walking camera is attached to a cover of the mobile communication device.

14. The method according to claim 10, further comprising image processing on one or more images produced by said walking camera.

15. The method according to claim 14, wherein image processing includes execution of routines to identify within one or more walking camera images obstacles in a path of the mobile communication device assembly.

16. The method according to claim 15, further comprising generating an alert signal responsive to a detection of an obstacle in a path of the mobile communication device assembly.

17. The method according to claim 10, further comprising processing location related information and displaying location related indicators on the display of the mobile communication device.
